(19) United States
(12) Patent Application Publication
(10) Pub. No.: US 2012/0017765 A1
(43) Pub. Date: Jan. 26, 2012

(54) COFFEE MAKER HAVING A BEAN GRINDER AND COFFEE BEAN GRINDER

(75) Inventors: Chi Wah Leung, Hong Kong (CN); Shek Chuen Luk, Hong Kong (CN); Kam Ming Tsang, Hong Kong (CN)

(73) Assignee: SIMATELEX MANUFACTORY CO. LTD., Chaiwan (HK)

(21) Appl. No.: 12/840,531

(22) Filed: Jul. 21, 2010

(51) Int. Cl. A47J 31/42

(52) U.S. Cl. 99/286

(57) ABSTRACT

A coffee maker or coffee bean grinder has a bean hopper for storing coffee beans, a bean grinder for grinding coffee beans into coffee grounds, and a bean delivery device for delivering a quantity of beans from the bean hopper to the bean grinder. The bean delivery device has a bean receptacle and is movable between first and second positions. In the first position, the bean receptacle communicates with the bean hopper and, in the second position, the bean receptacle communicates with the bean grinder. A controller controls movement of the bean delivery device between the first and second positions

### FIELD OF THE INVENTION

The present invention relates to coffee makers and in particular to drip-type coffee makers. The invention also relates to coffee bean grinders.

### BACKGROUND TO THE INVENTION

One method of making coffee includes passing heated water through coffee grounds in order to infuse the water with coffee flavor and aroma. A common type of coffee maker that employs this method is the so-called “drip-type” or “filter” coffee maker. Filter coffee makers comprise a water reservoir and a brew basket for receiving coffee grounds. A delivery tube or other water passage takes water from the water reservoir, through an in-line water heater, and delivers it to a spreader above coffee grounds in the brew basket. The heated water passes through the coffee grounds and in to a carafe, cup or other vessel.

The art to making good coffee relies not only on the correct water temperature and wetting time, but also on the quantity of water and grind coffee used in preparing the brew. Opinions vary widely but organizations such as the National Coffee Service Association recommend a ratio of approximately 11 grams of coffee to 8 fluid ounces of water.

One of the problems with known coffee makers, and in particular domestic or home use coffee makers, is the need to constantly measuring out exact quantities of water and coffee when making a brew. It is often the case that the number of cups, or quantity of coffee, may varies from brew to brew. Thus, there is a need to constantly adjust measurements and to work out exact quantities for each brew. One solution practiced by many users of domestic or home coffee makers is to measure out a known fixed quantity of coffee and water for each brew. For example a user may place three scoops of coffee in the brew basket for one full load of water. This can result in coffee wastage or in more extreme cases a shortage of coffee requiring a second brew which may only be partly consumed. As a result many users resort to rule of thumb guides such as “one scoop per cup plus one for the pot”. Such methods are imprecise often resulting in variable brew quality which detracts from the coffee drinking experience.

### SUMMARY OF THE INVENTION

It is an object of the present invention to overcome, or at least eliminate, the above-mentioned problem with known coffee makers, in particular domestic or home use coffee makers, by providing a coffee maker and a method of operating coffee maker which may be used to produce a consistent strengthen and flavor of coffee from brew to brew regardless of whether a small or large number of cups is being prepared. It is a further or alternative object of the invention to provide a coffee bean grinder.

There is disclosed herein a coffee maker and coffee bean grinder that have a bean hopper for storing coffee beans, a bean grinder for grinding coffee beans into coffee grounds and a bean delivery device for delivering a quantity of beans from the bean hopper to the grinder. The bean delivery device has a bean receptacle and is movable between first and second positions. In the first position the bean receptacle communicates with the bean hopper and in the second position the bean receptacle communicates with grinder. A controller controls movement of the bean delivery device between the first and second positions.

The bean delivery device can be a wheel for rotational movement between the first and second positions. In a preferred embodiment first and second positions are offset 180 degrees with respect to each other, but other offsets are possible. Where a 180 degree offset is used the wheel has a second bean receptacle offset 180 degrees with respect to the other bean receptacle. In other embodiments the bean delivery device can be a reciprocating member movable between the first and second positions

The bean receptacle(s) have a first opening in a first side of the wheel for communicating with the bean hopper to receive beans within the receptacle(s), and a second opening in a second side of the wheel for communicating with the grinder.

Preferably two motors are provided. A first motor operates the grinder and a second motor for operates the bean delivery device so that the delivery device and grinder blades can be operated independently.

A coffee maker also has a water reservoir and a water level sensor located in the water reservoir. The controller can be configured to control movement of the bean delivery device based on the signal from the water level sensor. There can also be a user input having two or more user selectable preference. The controller is in communication with the user input and can alternatively control movement of the bean delivery device based on the signal from the water level sensor and/or a second signal from the user input.

Further aspects of the invention will become apparent from the following description, which is given by way of example only.

### BRIEF DESCRIPTION OF THE DRAWINGS

Embodiments of the invention will now be described by way of example only and with reference to the accompanying drawings in which:

FIG. 1 is a front graphical projection of a coffee maker according to the invention,

FIG. 2 is a partial front view of the coffee maker,

FIG. 3 is a back section view of the coffee maker,

FIG. 4 is a side section view of the coffee maker,

FIG. 5 is a partial back graphical projection showing a water detection mechanism of the coffee maker, and

FIG. 6 is a flow chart of a preferred operation sequence of the coffee maker.

FIG. 7 is a front graphical projection of hopper, grinder and brew basket components of an embodiment of a coffee marker incorporating a rotary bean dispenser,

FIG. 8 is a section graphical projection through the components of FIG. 7 further illustrating the bean dispenser and drive motor of the bean dispenser,

FIG. 9 is a graphical projection of a further embodiment of hopper and grinder components of a coffee maker incorporating a linear bean dispenser,

FIG. 10 is a side view of the components of FIG. 10,

FIG. 11 is a section side view of FIG. 10 showing a first operational position of the linear dispenser—the solid grey regions represent coffee beans, and

FIG. 12 is a second section side view of FIG. 10 showing the linear dispenser in a second position—the solid grey regions represent coffee beans.

### DESCRIPTION OF THE PREFERRED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

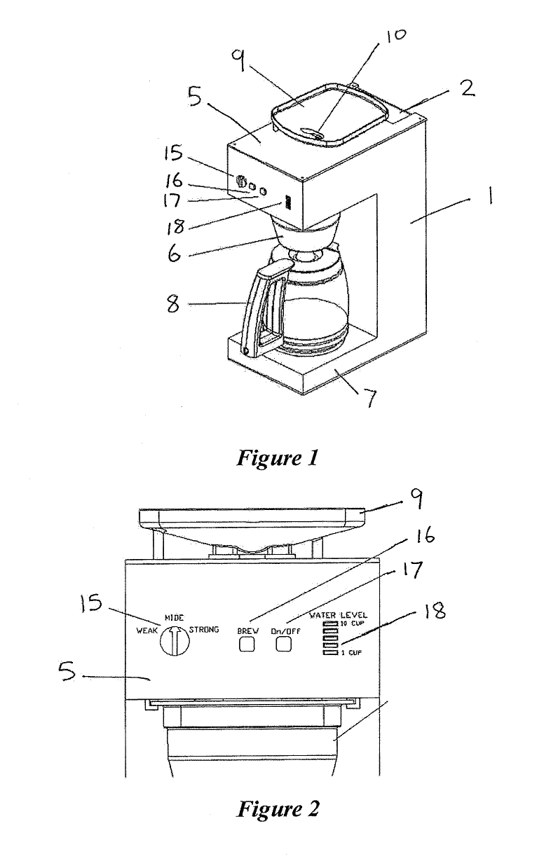

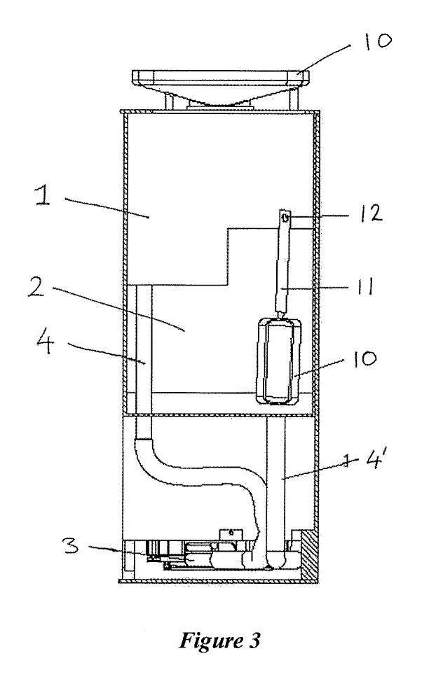

Referring to FIGS. 1 through 5, there is shown a coffee maker according to the invention comprising a coffee maker housing having a main body portion (1) housing a water supplying reservoir (2), an in-line water heater (3) and a water delivery passage (4). The main body (1) of the housing also has a head portion (5) to the lower side of which is attached a brew basket (6). On a lower part of the body is a base portion (7) which supports a carafe (8) below the brew basket (6). In use, water from the supplying reservoir (2) is heated by the in-line water heater (3) and passes up the deliver passage (4) to the brew basket (6), which contains a quantity of coffee grounds. The heated water passes through the coffee grounds, is infused with coffee flavour and aroma and collected in the carafe (8).

Located on the top of the head portion (5) is a bean hopper (9) having an opening (10) at its lowermost point. The bean hopper (9) can be arranged to hold whole coffee beans or to accept a coffee bean container such that, in either case, coffee beans can pass through the opening (10) in the lower part of the hopper (9). Located within the head (5) of the coffee maker is a coffee bean grinder (21) which communicates with both the opening (10) in the bean hopper and with the brew basket (6). The coffee bean grinder (21) is of a type known in the art and is operated by an electric motor (22). When the motor (22) is energized the grinder (21) operates drawing beans from the bean hopper (9) through opening (10) grinding the beans into coffee grounds which fall into the brew basket (6).

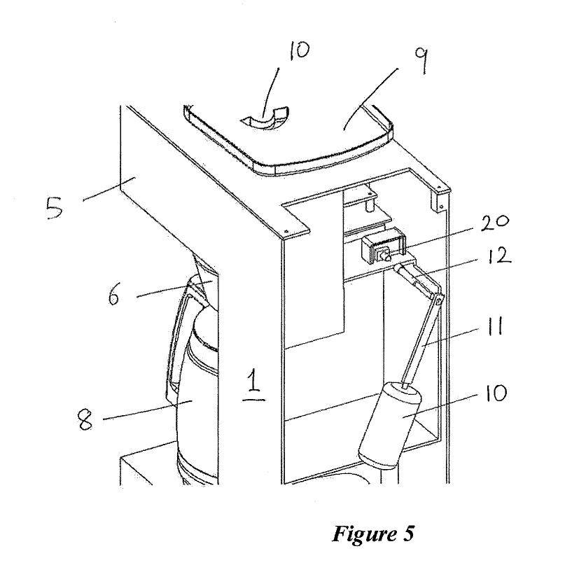

Referring specifically to FIG. 5, located within the water supplying reservoir (2) is a float-type level detector. The float-type level detector comprises a rotatably mounted shaft (12) extending into the water supplying reservoir (2) adjacent a top of the water supplying reservoir (2). At an end of the shaft (12) within the water supplying reservoir (2) is a float arm (11) which has a float (10) connected to its distal end. The float (10) floats on the top of any water within the reservoir (2). When the water level raises within the reservoir the float rises rotating the shaft (12). When the water level falls within the reservoir the float falls rotating the shaft (12) in an opposite direction. Located within the coffee maker housing at the distal end of the shaft (12) is a rotary-type variable resistor (20). The rotary-type resistor (20) is connected to the shaft (12) such that when the shaft rotates with movement of the float in response to the water level within the reservoir (2), the variable resistor is turned. Thus, by determining the position of the variable resistor (20), by measuring its resistance value, and comparing the resistance value with the mapping chart or table, the water level within the water reservoir can be determined.

In FIG. 2 there is shown a front end of the head portion (5) of the coffee maker housing which contains coffee maker controls for operating the coffee maker by a user. The controls includes a rotary selector switch (15) for selecting a coffee strength, for example a three position switch for allowing the selection of weak, mild and strong coffee flavours, a first push button (16) for beginning a brew cycle of the coffee maker and a second button (17) for turning the coffee maker on/off. The front panel of the coffee maker head (5) also has a water level indicator (18) which is in the form of a series of LED lights that illuminate sequentially to indicate water level in known fashion. Located within the head (5) of the housing is a circuit board (19) for example a printed circuit board (PCB) to which the input and indicate means (15, 16, 17, 18) are mounted. Also mounted to the circuit board (19) is a microprocessor (23) for controlling operation of the coffee maker. The microprocessor (23) is in communication with the inputs (15, 16, 17) and indicator (18) by electrical conductors formed on the circuit board (19) in known manner. The microprocessor (23) is also connected to the variable resistor (20) of the water level indicator and to a relay for operating the coffee grinder motor (22).

The coffee maker according to the invention overcomes problems with prior art coffee makers by an operating method which provides control quantity the amount of ground coffee in the brew basket (6) based upon the selected coffee strengthen—weak, mild or strong input by selector switch (15)—and/or the amount of water in the water reservoir (2). In the most basic embodiment of the invention the coffee maker is operated by the microprocessor (23) such that a fixed volume of coffee beans is deposited in the brew basket (6) based upon the setting of the strength select switch (15). For a mild brew the controller (23) operates the coffee grinder motor (22) for less time so that a minimum amount of coffee grounds are deposited in the brew basket (6). For a medium brew the controller (23) operates the grinding motor (22) for an average amount of time putting an average, or medium, amount of coffee grounds in the brew basket (6). For a strong brew the controller (23) operates the grinding motor (22) for a longer period of time at a deposit a greater amount of coffee beans in the brew basket (6). The microcontroller (23) uses the float switch in order to determine the level of water in the water reservoir (2) and indicates the water level on the water level indicator (18) viewable by the user. In this way the user can accurately fill the water reservoir (2) to a desired level based on experience. This makes it much simpler for a user to gauge the correct quantities of coffee and water for different brews and to obtain more consistent strength and flavour of coffee from consecutive brew cycles.

In an alternative, and preferred, embodiment of the invention the microcontroller operates the grinding motor (22) for different lengths of time based on both the brew strength selected via the brew selector switch (15) and on the water level within the reservoir (2). Thus, the length of time that the microprocessor (23) operates the grinding motor (22) is based not only on the strength selected but on the water level. So, for example, if a weak brew is selected and the water reservoir is full more coffee grounds are needed than if a weak brew is selected and the reservoir is half full (or half empty). A look-up or mapping table can be used by the microcontroller (23) in order to determine the amount of coffee grounds needed depending on the water level in the water reservoir (2). The water level in the water reservoir (2) can be determined by a separate mapping table mapping the resistance value of the variable resistor (20) to the water level in the reservoir (2) as previously discussed. A third mapping table can be used to map the length of time that the coffee grinding motor (22) must be operated for depositing a certain amount of coffee grounds into the brew basket (6). Alternatively, a single mapping table can be used to map a resistance value of the variable resistor (20) and a brew strength setting of the selector switch (15) to a grinding motor (22) operating time. Such arrangements of mapping tables are common in the microprocessor programming art and well within the capability of a skilled addressee. The various quantities need for a quality brew of coffee are well-known, but essential to the invention. One typical value quoted is 11 grams of grounds to 8 ounces of water.

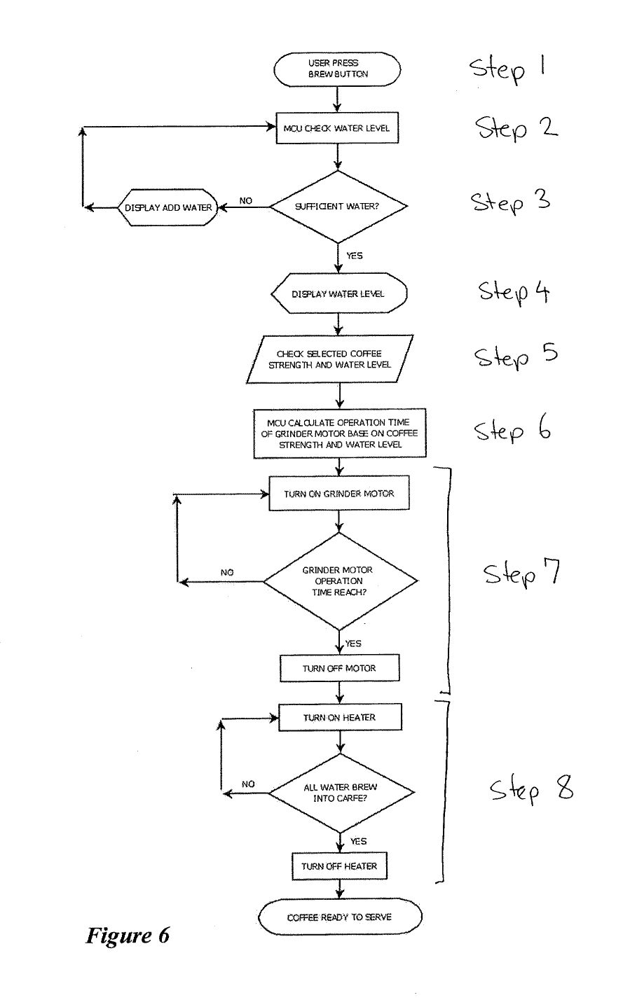

FIG. 6 shows a preferred operating method of the invention. The method assumes that a user has placed coffee beans in the bean hopper (9) and water in the water reservoir (2). At step 1 of FIG. 6 a user processes the brew button (16). At step 2 the microprocessor (23) determines the water level within the reservoir using one of the methods described above. At step 3 the microprocessor determines whether there is sufficient water in the water reservoir for making a brew of coffee. If insufficient water is present a warning can be given to the user.

At step 4 the microprocessor displays (23) the water level within the reservoir (2) on the water level indicator (18). At step 5 the microprocessor checks a selected coffee strength set at coffee strength selector switch (15). At step 6 the microprocessor (23) calculates the preferred/needed operating time of the grinding motor (22) based on the coffee strength selection and the water level as previously described. At step 7 the microprocessor (20) operates the grinding motor (22) for the determined operating time and after the required time turns-off the grinding motor (22). At step 8 the microprocessor (23) operates the in-line water heater (3) to heat water in the water reservoir (2) and deliver it to the brew basket (6). The microprocessor (23) continues to operate the water heater (3) until all the water in the reservoir (2) is used up. This can be determined via the water level float switch. A safety thermostat to shut-off the water heater (3) should the reservoir (2) run dry can also be included. After the water heater (3) is switched off the coffee is ready to serve.

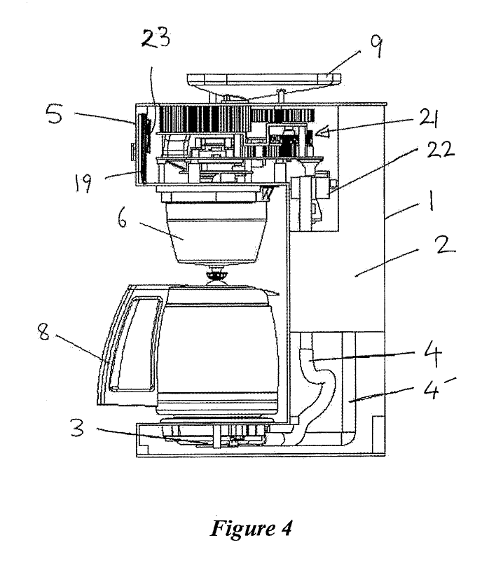

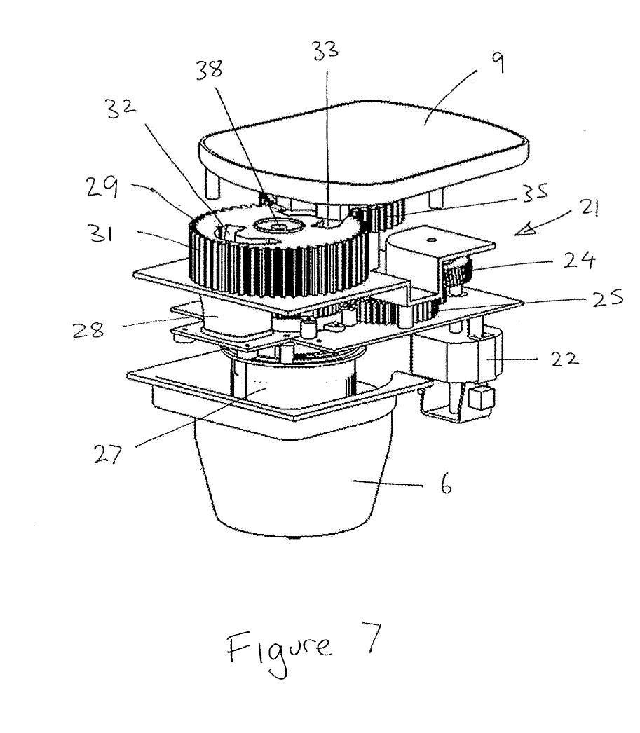

FIGS. 7 and 8 illustrate the hopper (9), grinder mechanism (21) and brew basket (6) components of an alternative embodiment of a coffee maker. The location of these components within the overall coffee maker can be readily derived from FIG. 4. The grinder mechanism (21) comprises grinding blades (26) located within a grinding housing (27) above the brew basket (6). The grinding blades (26) are operated by the grinding motor (22) via a plurality of gears (24, 25). The arrangement of blades (26) for grinding coffee beans is well-known in the art. Delivery of coffee beans to the grinder blades (26) is via a grinder inlet chute (28). Coffee beans are delivered from an outlet (30) of hopper 9 to the grinder inlet chute (28) via a bean delivery wheel (29).

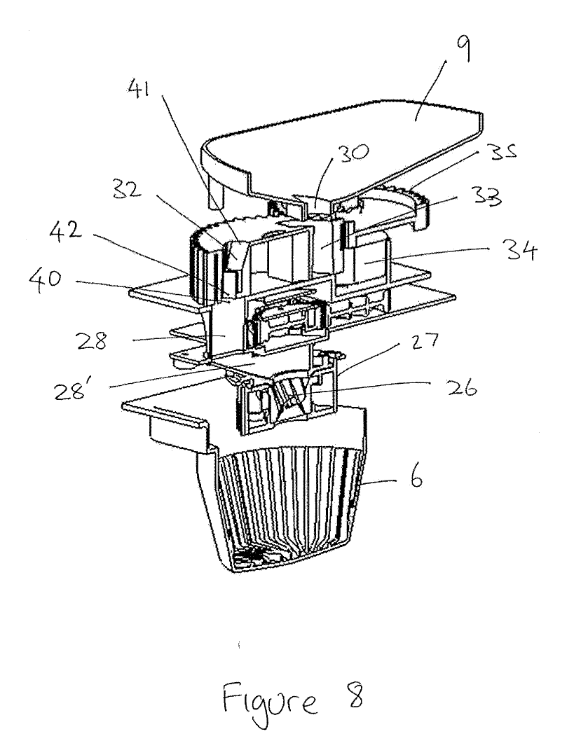

The bean delivery wheel (29) comprises a circular wheel having a toothed outer periphery (31) and two diametrically opposed arcuate shaped receptacles (32, 33). The receptacles (32, 33) have openings (41, 42) at both ends in the form arcuate apertures through the delivery wheel (29). The delivery wheel (29) is positioned on a rotational axis (38) located equidistant between outlet (30) of hopper (9) and the opening (40) in the top of grinder inlet chute (28). The arrangement is such that when the delivery wheel (29) is rotationally positioned in one of two positions, one of which is 180 degrees offset from the other, the outlet (30) of the bean hopper (9) is aligned with the upper opening (41) of one arcuate receptacle, for example receptacle (33) as illustrated in FIGS. 8 and 9, and the other arcuate receptacle, for example receptacle (32) is illustrated in FIGS. 8 and 9, is located above the grinder inlet chute (28) such that its lower opening (42) aligns with the opening (40) in the top of grinder inlet chute (28). The bean delivery wheel (29) is rotated by a motor (34) and pinion (35) which engages with the toothed outer periphery (31) of the wheel (29). Two motors are provided, the wheel motor (34) and grinder motor (22), so that the delivery device and grinder blades can be operated independently. When an arcuate receptacle (33) is located below outlet (30) of bean hopper (9) the receptacle (33) fills with a known, measurable, quantity of coffee beans by means of gravity. When the delivery wheel (29) is rotated 180 degrees so that the bean filled arcuate receptacle (33) is then located above the grinder inlet chute (28) the beans fall through the lower opening (42) of the receptacle into the grinder inlet chute (28) and are carried to the grinding blades (26) by means of gravity. The second arcuate receptacle (32) is now beneath the opening (30) and hopper (9) and fills with a known quantity of coffee grounds. A further 180 degrees rotation of the delivery wheel (29) delivers the coffee grounds in second arcuate receptacle (32) to the grinder inlet chute (28) and arcuate receptacle (33) again fills with a known quantity of coffee grounds.

The receptacles hold a measured quantity of coffee beans, which is made known to the controller either by programming the quantity into the controller or by storing the quantity in non-volatile electronic memory accessible by the controller. The controller (23) can operate delivery wheel (29) and so control the quantity of coffee beans delivered to the grinder (26) and thus the amount of coffee grounds in brew basket (6). The controller (23) can control the number of full rotations or half rotations of the delivery wheel (29) based on input from the input selective switch (15) and/or the amount of water in the water reservoir (2) as previously described in order to control the amount of grounds in the brew basket and thus the strength of the brew. The grinder motor (22) is operated continuously to grind all beans delivered to the grinder (26).

Although the receptacles (32, 33) are accurate in the referred example this is not essential to the invention and they could be any suitable shape adapted to the shape of outlet (30) of hopper (9) or the inlet (40) of the grinder inlet chute (28). Further, while in the described embodiment the delivery wheel (29) has two receptacles (32,33) and turns 180-degrees for movement of the receptacles between the hopper outlet (30) and grinder inlet chute (28), it will be apparent to a person skilled in the art that the delivery wheel may have just one receptacle or may have more than two receptacles, and that the hopper outlet and grinder inlet chute may be less than 180 rotational degrees of the wheel apart. For example, the hopper outlet and grinder inlet chute maybe only slightly misaligned with the wheel on an offset axis such that it turns a small number of degrees to align a receptacle between the hopper outlet and grinder inlet chute. In one such embodiment the delivery wheel has four receptacles spaced 90-degrees apart and turns 90-degrees to move one receptacle between the hopper outlet and grinder inlet chute. A full 360-degree rotation results in each receptacle being sequentially aligned with the hopper outlet and then the grinder inlet chute to deliver four “loads” of coffee beans to the grinder.

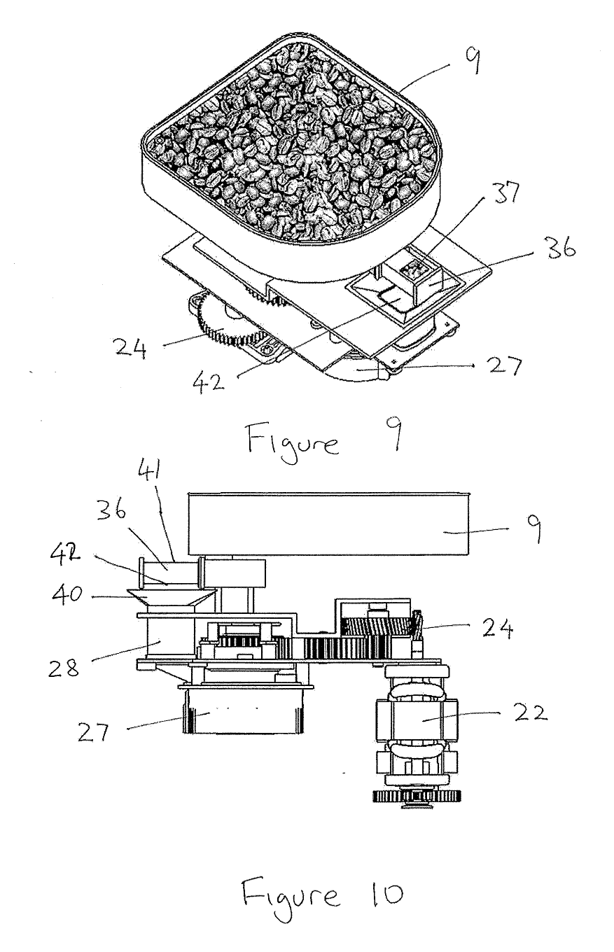

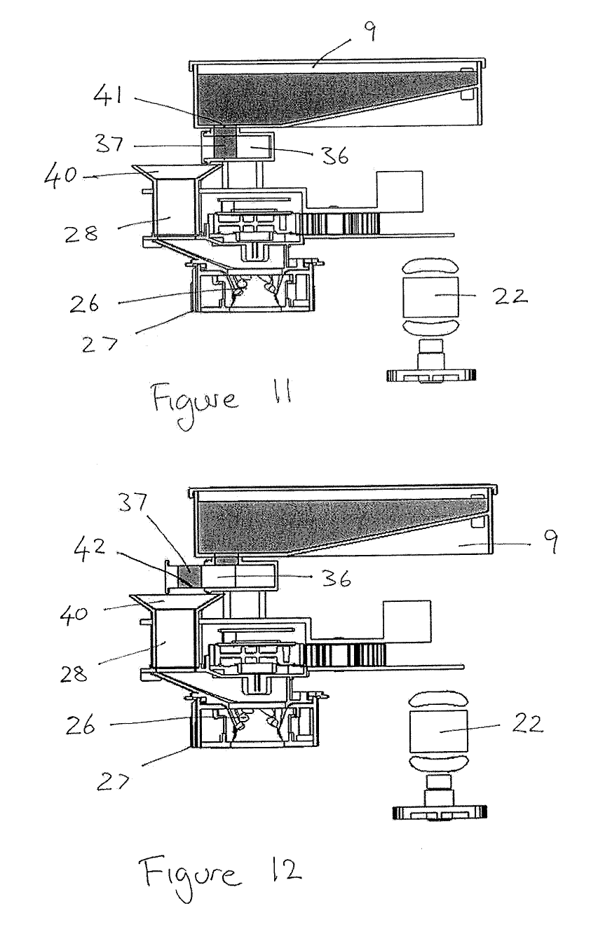

FIGS. 9 through 12 show a second embodiment of a bean delivery device that can deliver a known, measured, quantity of beans from the bean hopper (9) to the grinder inlet chute (28). In this arrangement the delivery device between the outlet (30) of the hopper (9) and the grinder inlet chute (28) is a reciprocating delivery block (36) having a single bean receptacle (37) with openings in both the top and bottom of the receptacle (37) in the form an aperture through the block (36). Reciprocating motion of the block (36) is achieved via a motor driven cam arrangement or a reciprocating solenoid arrangement. When the reciprocating block (36) is in a first, inward, position as illustrated in FIG. 11 the receptacle (37) aligns with opening (30) in the bottom of hopper (9) and the receptacle (37) fills with a known, measured, quantity of coffee beans by means of gravity. In FIG. 11 coffee beans are represented by grey regions. When the reciprocating block (36) is move to a its second, extended, position shown in FIG. 12 the receptacle (37) is aligned above the grinder inlet chute (28) and coffee beans in the receptacle (37) fall through the bottom opening (42) of the receptacle (37) into the chute (28) and to the grinding blades (26) by means of gravity. For each full reciprocating (in and out) motion of the reciprocating block (36) a measurable quantity of coffee beans is delivered from the hopper (9) to the grinding blades (26). In and out motion of the reciprocating block (36) is controlled by the microcontroller (23). The microcontroller (23) can thereby control the quantity of the coffee beans delivered to the grinding blades (26) in accordance with input from the selective switch (15) and/or the amount of water in the water reservoir (2) to control brew strength as previously described.

Thus, according to the invention there is a coffee maker and a method of operating a coffee maker which can repeatedly produce a consistent strength and flavour coffee brew regardless of the number of cups or the varying tastes of the user.

A coffee bean delivery system for delivering a measured quantity of coffee beans from a bean hopper to a bean grinder is described as practiced in a coffee maker. Separate coffee grinders are also. The bean delivery system can also be practiced in a coffee grinder. In a preferred embodiment such a coffee grinder includes a bean hopper for storing coffee beans, a bean grinder for grinding coffee beans into coffee grounds, and a bean delivery device for delivering a quantity of beans from the bean hopper to the grinder. The bean delivery device has bean receptacles and is movable between first and second positions in which the bean receptacles communicate with the bean hopper and grinder respectively. Coffee grounds are collected in a vessel for transfer to a storage container or directly to the brew basket of a coffee maker. The grinder preferably has two motors. A first motor operates the grinder blades and a second motor operates the bean delivery device so that the delivery device and grinder blades are separately operable. A controller in the grinder controls the motors. A user input on the grinder is provided for allowing a user to select a quantity of beans to grind. The controller determines the number of operations of the bean delivery device to achieve the selected quantity.

In the above-described embodiment various preferred examples are given. It must be appreciated that improvements and/or modifications obvious to those skilled in the art are not excluded from the scope of the present invention. For example, in the description a float-type water level detection means is included. Various other mechanical or electronic water level detectors and sensors are known in the art and should be considered within the scope of the present invention.

1. A coffee maker comprising:
a bean hopper for storing coffee beans,
a bean grinder for grinding coffee beans into coffee grounds,
a brew basket for receiving coffee grounds from the bean grinder,
a bean delivery device for delivering a quantity of beans from the bean hopper to the bean grinder, the bean delivery device comprising a first bean receptacle, the bean delivery device being movable between first and second positions, wherein, in the first position, the first bean receptacle communicates with the bean hopper, and, in the second position, the first bean receptacle communicates with the bean grinder, and
a controller operable to control movement of the bean delivery device between the first and second positions.

2. The coffee maker of claim 1 wherein the bean delivery device includes a wheel for rotational movement between the first and second positions.

3. The coffee maker of claim 2 wherein the first and second positions are offset 180 degrees with respect to each other.

4. The coffee maker of claim 3 wherein the wheel includes a second bean receptacle offset 180 degrees with respect to the first bean receptacle.

5. The coffee maker of claim 3 wherein the first and second bean receptacles have a first opening in a first side of the wheel for communicating with the bean hopper to receive beans within the first and second receptacles, and a second opening in a second side of the wheel for communicating with the bean grinder.

6. The coffee maker of claim 1 wherein the bean delivery device includes a reciprocating member movable between the first and second positions.

7. The coffee maker of claim 1 further comprising a first motor for operating the bean grinder and a second motor for operating the bean delivery device, the first and second motors being separately operable by the controller.

8. The coffee maker of claim 1 further comprising a water reservoir and a water level sensor located in the water reservoir, the controller controlling movement of the bean delivery device based on a signal from the water level sensor.

9. The coffee maker of claim 8 further comprising a user input having at least two user selectable preferences, the controller being in communication with the user input and further controlling movement of the bean delivery device based on the signal from the water level sensor and a signal from the user input.

10. The coffee maker of claim 8 wherein the first receptacle holds a measured quantity of coffee beans, the measured quaintly being known to the controller.

11. A coffee bean grinder comprising:
a bean hopper for storing coffee beans,
a bean grinder for grinding coffee beans into coffee grounds,
a bean delivery device for delivering a quantity of beans from the bean hopper to the bean grinder, the bean delivery device comprising a first bean receptacle, the bean delivery device being movable between first and second positions, wherein, in the first position, the first bean receptacle communicates with the bean hopper, and, in the second position, the first bean receptacle communicates with the bean grinder, and
a controller operable to control movement of the bean delivery device between the first and second positions.

12. The coffee bean grinder of claim 11 wherein the bean delivery device includes a wheel for rotational movement between the first and second positions.

13. The coffee bean grinder of claim 12 wherein the first and second positions are offset 180 degrees with respect to each other.

14. The coffee bean grinder of claim 13 wherein the wheel has a second bean receptacle offset 180 degrees with respect to the first bean receptacle.

15. The coffee bean grinder of claim 13 wherein the first and second bean receptacles have a first opening in a first side of the wheel for communicating with the bean hopper to receive beans within the first and second receptacles, and a second opening in a second side of the wheel for communicating with the bean grinder.

16. The coffee bean grinder of claim 11 wherein the bean delivery device includes a reciprocating member movable between the first and second positions.

17. The coffee bean grinder of claim 11 further comprising a first motor for operating the bean grinder and a second motor for operating the bean delivery device, the first and second motors being separately operable by the controller.

18. The coffee bean grinder of claim 11 further comprising a user input having at least two user selectable preferences, the controller being in communication with the user input and controlling movement of the bean delivery device based on a signal from the user input.

19. The coffee maker of claim 9 wherein the first receptacle holds a measured quantity of coffee beans, the measured quaintly being known to the controller.
